(19) United States
(12) Patent Application Publication
(10) Pub. No.: US 2010/0171735 A1
(43) Pub. Date: Jul. 8, 2010

(54) DATA DRIVING CIRCUIT FOR FLAT DISPLAY PANEL WITH PARTIAL MODE AND METHOD FOR PROCESSING PIXEL DATA OF PARTIAL WINDOW

(75) Inventor: Chia-Hsin Tung, Hsinchu City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/541,422

(22) Filed: Aug. 14, 2009

(30) Foreign Application Priority Data
Jan. 6, 2009 (TW) 98100233

(51) Int. Cl. G06F 3/038

(52) U.S. Cl. 345/213

(57) ABSTRACT

A data driving circuit for a flat display panel with a partial mode and a method for processing pixel data of a partial window. The driving circuit includes an input register and a data collection circuit. When the driving circuit is in the partial mode, it determines whether to sequentially read pixel data for pixels of the pixel data of the window from a data area according to a boundary of the window and a scan count, and temporarily stores the pixel data into the data collection circuit. When the scan count indicates that the window is to be displayed, the data collection circuit selects pixel data for pixels from the temporarily stored pixel data for the pixels and accordingly produces pixel data for pixels to the input register so as to sequentially output the pixel data of the window to drive the display panel to display the window.

This application claims the benefit of Taiwan application Serial No. 98100233, filed Jan. 6, 2009, the subject matter of which is incorporated herein by reference.

### BACKGROUND OF THE INVENTION

1. Field of the Invention

The invention relates in general to a pixel data processing method and a driving circuit for a flat display panel, and more particularly to a pixel data processing method and a data driving circuit for a partial window of a flat display panel.

2. Description of the Related Art

With regard to a source driver of a typical liquid crystal display panel, a data latch is provided to output digital pixel data of a certain row of pixels in a pixel array to a digital-to-analog converter, which converts the digital pixel data into analog display signals to drive the row of pixels. In addition, the data latch captures the pixel data of one row of pixels from a data source, such as the memory, through a shift register and an input register and transfers the captured pixel data to the input register for storage so that the pixel data can be thus outputted to the data latch. In this process, it is conventionally to capture the data of one pixel at one time and output it to the input register for each clock time.

In a high-resolution display panel, however, it is conventionally required to capture the digital pixel data with a clock at a higher frequency. Some liquid crystal display panels display information via a partial window in order to save the energy. However, the above-mentioned method cannot effectively save the energy. Taking a handheld device having a small-sized liquid crystal display panel with the resolution of 480×864 as an example, a high-frequency clock of about 25 MHz is needed to control reading of each piece of pixel data at the scan frequency of 60 Hz. Thus, the higher the clock frequency is, the higher the corresponding power consumption is relatively. Under the condition that the battery of the handheld device has the limited capacity, the power-saving effect of the partial window is weakened due to the conventional driving method and structure.

In addition, when the conventional driving circuit of the liquid crystal display panel controls the partial window to display the area data, it tends to be influenced by the architecture of the data latch of the driving circuit such that the settings of the left and right boundaries cannot be arbitrarily designated. So, the conventional driving circuit cannot be applied more flexibly.

### SUMMARY OF THE INVENTION

The invention is directed to a method for processing pixel data of a partial window of a flat display panel and a data driving circuit. According to the embodiment of the invention, the driving circuit can capture the pixel data at the lower frequency. In addition, when the driving circuit of the flat display panel controls the partial window to display the area data, the left and right boundaries of the partial window can be arbitrarily designated such that the driving circuit can be applied more flexibly.

According to a first aspect of the present invention, a data driving circuit for driving a flat display panel with a partial mode is provided. The data driving circuit includes an input register and a data collection circuit. The input register stores pixel data of one row of pixels of the display panel and outputs the pixel data of the one row of pixels. The input register receives pixel data of a plurality of pixels every time to provide pixel data of the row of pixels. When the data driving circuit is in a partial mode, the data collection circuit determines whether to sequentially read pixel data of a plurality of pixels of the pixel data of a partial window from a data area according to a boundary of the partial window and a scan count and temporarily stores the read pixel data into the data collection circuit. When the scan count indicates that the partial window is to be displayed, the data collection circuit selects pixel data of a plurality of pixels from the temporarily stored pixel data of the pixels and accordingly produces the pixel data to the input register every time so as to sequentially output the pixel data of the partial window to drive the flat display panel to display the partial window. The data area stores each row of the pixel data of the partial window.

According to a second aspect of the present invention, a data collection circuit for sequentially processing pixel data of a partial window and thus providing the processed data to a data driving circuit of a flat display panel with a partial mode to display the partial window is provided. The data collection circuit includes a first-in-first-out (FIFO) memory cell, a data output selection unit and a control unit. The data output selection unit stores pixel data outputted from the FIFO memory cell, and produces processed pixel data of P pixels according to a data output selection signal every time. The control unit determines whether to output a data request signal according to a boundary of the partial window and a scan count so as to sequentially read pixel data of P pixels of the pixel data of the partial window from a data area and temporarily store the read pixel data into the FIFO memory cell. When the control unit determines that the scan count as indicating that the partial window is to be displayed, the control unit controls the FIFO memory cell to output the pixel data to the data output selection unit, and the control unit outputs the data output selection signal to make the data output selection unit select the pixel data of the P pixels from the stored pixel data outputted from the FIFO memory cell, and thus produce the pixel data of the P pixels, wherein P is a positive integer greater than 1.

According to a third aspect of the present invention, a method for sequentially processing pixel data of a partial window in a partial mode to provide a data driving circuit of a flat display panel to display the partial window is provided. The method includes the steps of: (a) determining whether to sequentially read pixel data of a plurality of pixels of the pixel data of the partial window from a data area to temporarily store the read pixel data into the memory cell according to a boundary of the partial window and a scan count when the data driving circuit is in the partial mode; and (b) selecting pixel data of P pixels from the temporarily stored pixel data of the pixels when the scan count indicates that the partial window is to be displayed, and thus producing pixel data of P pixels to the data driving circuit every time so as to sequentially output the pixel data of the partial window to drive the flat display panel to display the partial window. The data area stores each row of the pixel data of the partial window, and P is a positive integer greater than 1.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a data driving circuit for a flat display panel according to an embodiment of the invention.

FIG. 2 shows implementation of the embodiment of FIG. 1, wherein two pieces of pixel data are captured to an input register every clock.

FIG. 3 shows a partial window and a boundary of a display panel.

FIG. 4 is a block diagram showing an embodiment of the data collection circuit of FIG. 2.

FIG. 5 is a schematic illustration showing an embodiment of the operation of the data collection circuit of FIG. 4 when vertical boundaries of a partial window are respectively an even number and an odd number.

FIG. 6 is a schematic illustration showing an embodiment of the operation of the data collection circuit when the vertical boundaries of the partial window are odd numbers.

FIG. 7 is a schematic illustration showing an embodiment of the operation of the data collection circuit when the vertical boundaries of the partial window are respectively an odd number and an even number.

FIG. 8 is a schematic illustration showing an embodiment of the operation of the data collection circuit when the vertical boundaries of the partial window are even numbers.

FIG. 9 shows a method for processing the pixel data of the partial window, for use in the data collection circuit of FIG. 4, according to an embodiment of the invention.

### DETAILED DESCRIPTION OF THE INVENTION

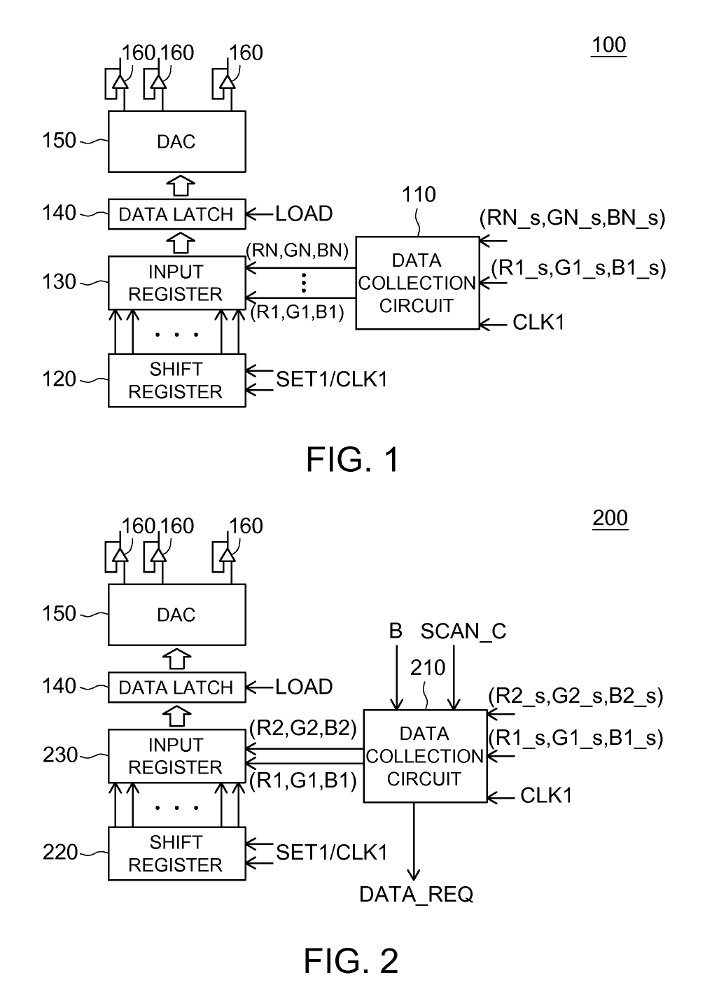

FIG. 1 is a block diagram showing a data driving circuit 100 for a flat display panel according to an embodiment of the invention. The driving circuit can control pixel data of a partial window of the flat display panel and process the pixel data to satisfy various requirements on the boundary of the partial window. In order to reduce the power consumption, the data driving circuit 100 captures the pixel data of a plurality of pixels from a video data source once for each clock of a clock signal CLK1, and thus can operate at a lower clock frequency.

The data driving circuit 100 includes a data collection circuit 110, a shift register 120, an input register 130, a data latch 140, a digital-to-analog converter (DAC) 150 and an output buffer 160. The data driving circuit 100 has at least two operation modes including a normal mode and a partial mode.

In the normal mode, the shift register 120 controls the captured pixel data of the pixels from the video data signal source at one time to be inputted to the input register 130 at one clock of the clock signal CLK1. For example, when the signal SET1 indicates starting, the shift register 120 starts to sequentially enable the temporarily memory spaces of the input register 130 and to sequentially temporarily store the pixel data of one row of pixels into the input register 130. The number of the temporarily memory spaces of the input register 130 enabled by the shift register 120 every time corresponds to the number of pieces of pixel data of the pixels captured at one time. For example, when the pixel data of two pixels is captured at one time and inputted to the input register 130, the shift register 120 enables two temporarily memory spaces of the input register 130 for temporarily storing the pixel data of the two pixels every time. In the above-mentioned example, the data paths and the input methods of the shift register 120 and the input register 130 may be used by the data collection circuit 110 in the partial mode. In addition, in other examples, the data paths and the number of pieces of data captured at one time in the normal mode and the partial mode may be properly modified.

The input register 130 provides the pixel data of one row of pixels to the data latch 140. The digital-to-analog converter 150 obtains the pixel data of the row of pixels from the data latch 140 and produces analog display signals by way of digital-to-analog conversion. Next, the analog display signal is processed by the output buffer 160 and then used to drive a plurality of data lines of the flat display panel, such as those of a liquid crystal display panel.

In the partial mode, the data driving circuit 100 controls the flat display panel to display the information, such as time, through a partial window of a display area. In addition, compared with the normal mode, the data driving circuit 100 and the associated circuits in the partial mode may operate in a power-saving mode and the overall power consumption may be decreased. The data collection circuit 110 provides the pixel data (R1, G1, B1) to (RP, GP, BP) of the pixels once for each clock.

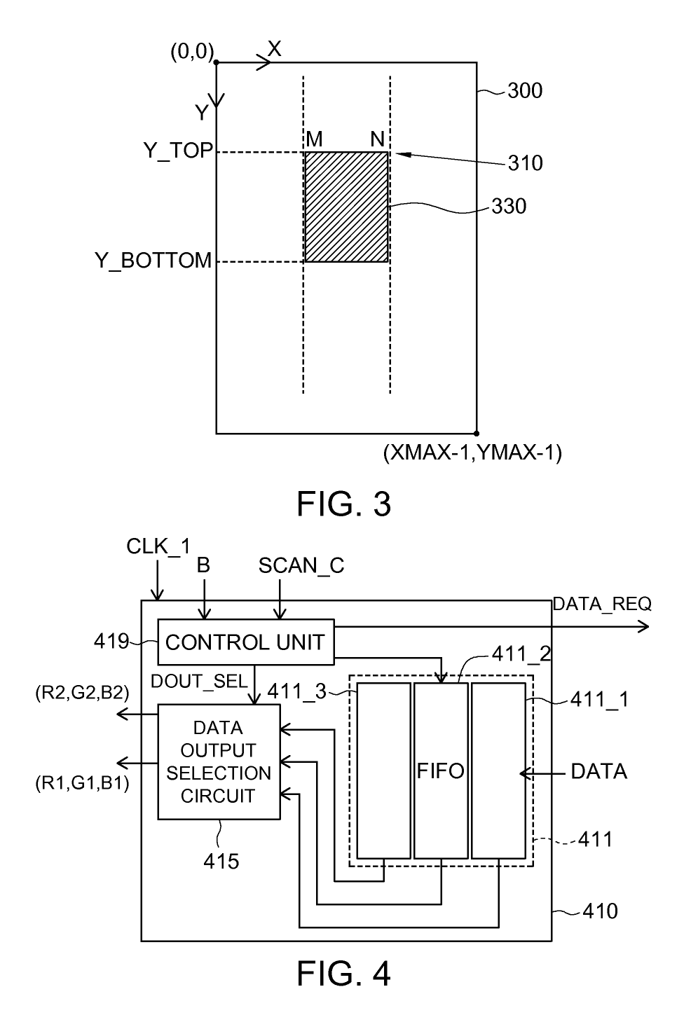

In order to smoothly and correctly display the pixel data of the partial window, it is necessary to consider the boundary problem and to properly set the pixel value of the area other than the partial window. FIG. 3 shows a partial window and a boundary of a display panel. Referring to FIG. 3, a display area 300 of a display panel has a partial window 330, the resolution of the display area 300 is XMAX·YMAX, such as 480×864; the partial window 330 has vertical boundaries x=M and x=N and horizontal boundaries y=Y_TOP and y=Y_BOTTOM, wherein XMAX≧N≧M≧0 and YMAX≧Y_BOTTOM≧Y_TOP≧0. In addition, the area other than the partial window 330, such as the area indicated by the arrow 310 and referred to as a non-partial window, is not used for displaying the information, so the pixel value of the non-partial window has to be set. For example, a fixed monochromatic color is used to set the pixel value of the non-partial window as corresponding to black or white. All the pieces of pixel data of the display area 300 are captured by the data driving circuit 100 to drive the display panel. Thus, when the data collection circuit 110 captures the pixel data, such as (R1_s, G1_s, B1_s), of the partial window 330 from a data source (e.g., a static memory), a processing method is determined to be applied according to the vertical boundary values M and N, which may be an odd number or an even number, and the values of the horizontal boundaries, and according to the scan signal of the current scan driving circuit (not shown). Thus, the pixel data corresponding to one row of pixels of the display area 300 is produced or the pixel data including the partial window 330 is provided according to the captured pixel data of the partial window 330 in conjunction with the pixel value of the non-partial window so that the pixel data of pixels of the row of pixels is provided for each clock at one time. The data source or the data area is, for example, the area of the memory for storing the pixel data of each row of pixels of the partial window.

In the following example, the data driving circuit for capturing the pixel data of an even number of pixels to the input register once for each clock at in the partial mode will be illustrated to explain how to smoothly and correctly display the pixel data in the partial window.

FIG. 2 shows implementation of the data driving circuit 100 of FIG. 1. As shown in FIG. 2, a data collection circuit 210 of a data driving circuit 200 processes the pixel data of the partial window captured from a data source (not shown), such as a memory (e.g., a static memory (SRAM) or a dynamic memory (DRAM)) according to a boundary value B of the partial window and a scan count SCAN_C, and provides the pixel data of two pixels, such as the RGB values or gray-level values (e.g., 8, 16 or 24 bits of values) of two pixels once for each clock. The boundary value B of the partial window represents M, N, Y_TOP and Y_BOTTOM shown in FIG. 3. The scan count SCAN_C represents which scan line is currently horizontally scanned, and may be provided by a timing control circuit of a panel driving system or may be obtained according to the vertical scan synchronous signal (V sync) and the clock signal (V clock) of the timing control circuit, for example. The above-mentioned pixel data of the two pixels is inputted to the data latch 140 through an input register 230, for example. In another example, the data driving circuit 200 may be implemented as producing the scan count SCAN_C itself according to the signal provided by the timing control circuit.

FIG. 4 is a block diagram showing an embodiment of the data collection circuit of FIG. 2. Referring to FIG. 4, a data collection circuit 410 includes a first-in-first-out (FIFO) memory cell 411, a data output selection unit 415 and a control unit 419. The control unit 419, implemented by a logic circuit or a microcontroller, for example, determines whether to output a data request signal according to a boundary of the partial window and a scan count so as to sequentially read the pixel data of P pixels of the pixel data of the partial window from the data area and temporarily store the read pixel data into the FIFO memory cell 411. The data output selection unit 415 stores the pixel data, outputted from the FIFO memory cell 411, in a FIFO manner, and produces the processed pixel data of the P pixels for each clock according to a data output selection signal DOUT_SEL, outputted from the control unit 419, and the clock signal CLK1, wherein P is a positive integer greater than 1. In this example, P is equal to 2, and the data output selection unit 415 outputs the pixel data (R1, G1, B1) and (R2, G2, B2) of two pixels. The data output selection unit 415 may be implemented by, for example, a register and a multiplexer or any other logic circuit.

In the partial mode, during the horizontal scanning of the display panel from the first row to the last row, the control unit 419 can determine whether the range of a block window 330 of FIG. 3 is scanned according to the boundary value B of the partial window and the scan count SCAN_C. Thus, the control unit 419 sequentially outputs the data request signal DATA_REQ so as to sequentially read the pixel data (DATA shown in FIG. 4) of the P pixels of the pixel data of the partial window from the data area, and to input the read pixel data to the FIFO memory cell 411 for temporary storage. In this example, one pixel has RGB values. Thus, the FIFO memory cell 411 of FIG. 4 includes three FIFO units (hereinafter referred to as FIFO) 411_1 to 411_3 for respectively storing the R, G and B pixel data of each pixel coming from the data area. The three FIFOs 411_1 to 411_3 also output data to the data output selection unit 415.

The design of the data collection circuit 410 has to consider the boundary problem of the block window such that suitable pixel data of P pixels may be produced. If P is an even number, such as 2, the values of the first boundary and the second boundary may be classified into four conditions according to whether the value is the odd number or the even number.

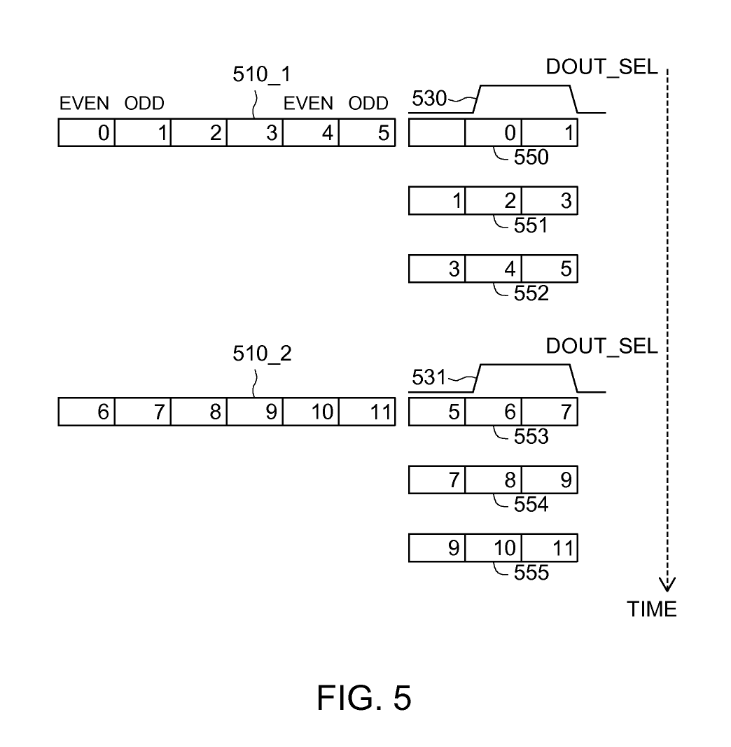

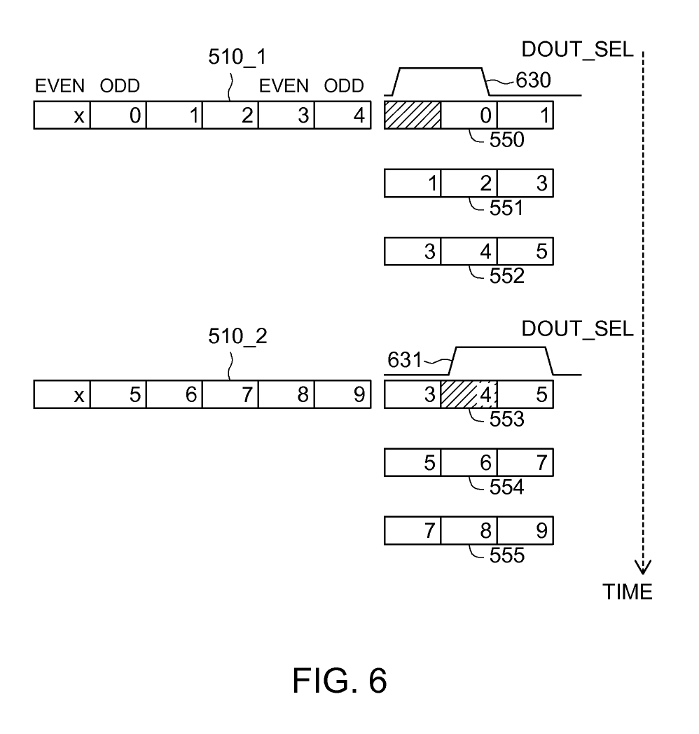

In the first condition, P is equal to 2, and the values M and N of the first and second vertical boundaries are respectively the even number and the odd number. FIG. 5 is a schematic illustration showing an embodiment of an operation of the data output selection unit 415 of the data collection circuit of FIG. 4 when the vertical boundaries of the partial window are respectively an even number and an odd number. For the sake of illustration, the rectangular frame at the left-hand side of FIG. 5 represents a portion 510_1 of one row of pixel data of the display area of the partial window to be displayed and a portion 510_2 of the successive second row, wherein the digit in one grid represents an n-th pixel of the partial window, wherein n is an integer number. The six rows 550 to 555 at the right-hand side of FIG. 5 illustrate the data input/output procedures in one memory of the data output selection unit 415, and the procedures of producing the pixel data (R1, G1, B1) and (R2, G2, B2) of two pixels by the data output selection unit 415 according to the data output selection signal DOUT_SEL. The same meanings are applied to FIGS. 6 to 8.

In FIG. 5, the symbol 550 represents that the memory of the data output selection unit 415 receives the pixel data of the first row of beginning P (P=2) pixels of the partial window. Because the values M and N are respectively the even number and the odd number, the control unit 419 outputs the data output selection signal DOUT_SEL, indicated by the symbol 530 of FIG. 5, to make the data output selection unit 415 select and output the pixel data of pixels 0 and 1. Thus, the pixel data of the front two pixels of the first row portion 510_1 is the pixel data of the pixels 0 and 1. Next, the symbol 551 represents that the memory receives the pixel data of the successive P (P=2) pixels of the first row of the partial window, and the previous pixel data of the pixels 0 and 1 is moved forwards. Similarly, the data output selection unit 415 selects and outputs the pixel data of the pixels 2 and 3. Furthermore, the symbol 552 represents that the memory receives the pixel data of the successive P (P=2) pixels of the first row of the partial window (i.e., the pixel data of the pixels 4 and 5), wherein the two pieces of data are the ending portions of the first row of the partial window. Similarly, the two pieces of data are also outputted. Thus, the pixel data of the first row portion 510_1 can be smoothly and correctly outputted. The symbols 553 to 555 illustrate the outputs of the pixel data of the successive second row of the partial window, wherein the final order is shown by the second row portion 510_2. The output of the pixel data of other portions of the partial window may be performed in a manner similar to the above, so detailed descriptions thereof will be not detailed for the sake of brevity.

In the second condition, P is equal to 2, and the values M and N of the first and second vertical boundaries are odd numbers. FIG. 6 is a schematic illustration showing an embodiment of the operation of the data output selection unit 415 of the data collection circuit of FIG. 4 when the vertical boundaries of the partial window are odd numbers.

In FIG. 6, the symbol 550 represents that the memory of the data output selection unit 415 receives the pixel data of the first row of beginning P (P=2) pixels of the partial window. Because the value M is an odd number, the control unit 419 outputs the data output selection signal DOUT_SEL, indicated by the symbol 630 of FIG. 6, to make the data output selection unit 415 select the pixel data of P (P=2) pixels and adjust the pixel data to produce the pixel data of the P pixels for output. The pixel data of the P pixels includes the setting value of an odd number (one in this example) of pixel(s) of the non-partial window (indicated by the hatched grid in front of the pixel 0 of 550) and the pixel data of the row of beginning odd number (one in this example) of pixel(s), that is, the pixel data of the pixel 0. Thus, the pixel data of the front two pixels of the first row portion 510_1 is the pixel data of one pixel of the non-partial window and the pixel data of the pixel 0 of the partial window. Next, the symbol 551 represents that the memory receives the pixel data of the first row of successive P (P=2) pixels of the partial window, and the pixel data of the previous pixels 0 and 1 is moved forwards. The data output selection unit 415 selects and outputs the pixel data of the pixels 1 and 2. Furthermore, the symbol 552 represents that the memory receives the pixel data of the successive P (P=2) pixels of the partial window, that is, the pixel data of the pixels 4 and 5. What is different from FIG. 5 is that the pixel 4 is the ending portion of the first row of the partial window, so the data output selection unit 415 selects and outputs the pixel data of the pixels 3 and 4.

Similarly, the symbols 553 to 555 of FIG. 6 represent the outputs of the pixel data of the successive second row of the partial window, and the final order is shown by the second row portion 510_2. In the condition indicated by 552, the pixel data of the pixel 5 is the beginning portion of the successive second row of the partial window, so the control unit 419 needs not to output the data request signal DATA_REQ again. Next, as shown by 553 of FIG. 6, the control unit 419 changes the selection position of the data output selection signal DOUT_SEL, and the data output selection unit 415 selects the pixel data of two pixels according to the data output selection signal DOUT_SEL shown by 631, and adjusts the selected pixel data to produce the pixel data of two pixels, which includes the setting value of one pixel of the non-partial window (indicated by the hatched grid in front of the pixel 5 of 553) and the pixel data of the row of beginning one pixel, that is, the pixel data of the pixel 5. The pixel data of the pixel 4 is modified into the setting value of the pixel of the non-partial window. For example, a constant, such as 0, is modified using a data mask. The outputs of the data of 554 and 555 and the pixel data of other portions of the partial window may be analogized, so detailed descriptions thereof will be omitted.

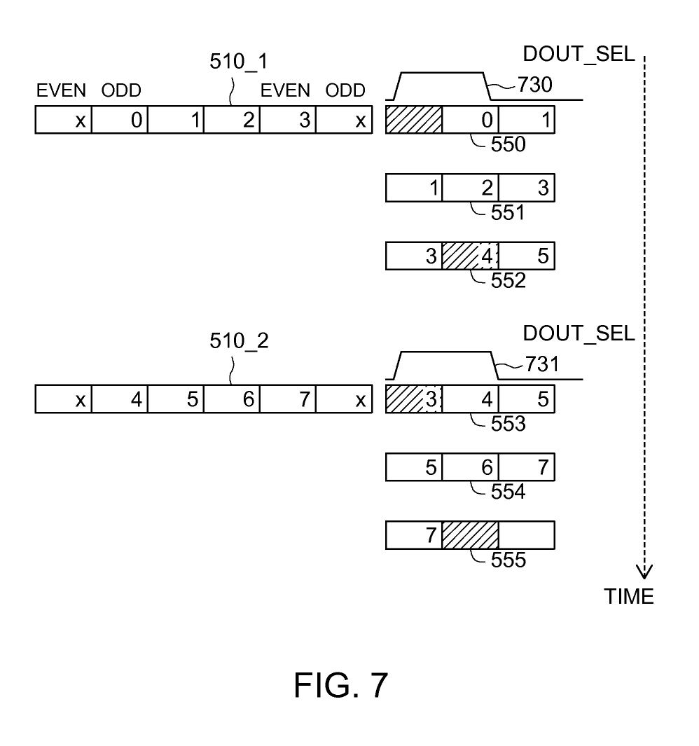

In the third condition, P is equal to 2, and the values M and N of the first and second vertical boundaries are respectively an odd number and an even number. FIG. 7 is a schematic illustration showing an embodiment of the operation of the data output selection unit 415 of the data collection circuit of FIG. 4 when the vertical boundaries of the partial window are respectively an odd number and an even number.

In FIG. 7, the symbol 550 represents that the memory of the data output selection unit 415 receives the pixel data of the first row of beginning P (P=2) pixels of the partial window. Because the value M is an odd number, the control unit 419 outputs the data output selection signal DOUT_SEL, indicated by the symbol 730 of FIG. 7, to make the data output selection unit 415 select and output the pixel data of P (P=2) pixels. The condition thereof is similar to that of 550 of FIG. 6. Thus, the pixel data of the front two pixels of the first row portion 510_1 is the pixel data of one pixel of the non-partial window and the pixel 0 of the partial window. Next, the operation of the symbol 551 of FIG. 7 is similar to that of the symbol 551 of FIG. 6. Furthermore, the symbol 552 represents that the memory receives the pixel data of the successive P (P=2) pixels of the partial window, that is, the pixel data of the pixels 4 and 5. What is different from FIGS. 5 and 6 will be described in the following. Because the pixel data of the pixel 3 is the ending portion of the first row of the partial window, the data output selection unit 415 selects the pixel data of P (P=2) pixels and adjusts the selected pixel data to produce the pixel data of the P pixels for output. The pixel data of the P pixels includes the pixel data of the row of ending odd number (1 in this example) of pixel (i.e., the pixel data of the pixel 3), and the setting value of an odd number (1 in this example) of pixel of the non-partial window (indicated by the hatched grid in back of the pixel 3 of 552).

Similarly, the symbols 553 to 555 of FIG. 7 represent the outputs of the pixel data of the successive second row of the partial window, and the final order is shown by the second row portion 510_2. In the condition indicated by 552, the pixel data of the pixel 4 is the beginning portion of the successive second row of the partial window, so the control unit 419 needs not to output the data request signal DATA_REQ again. Next, as shown by 553 of FIG. 7, the control unit 419 does not change the selection position of the data output selection signal DOUT_SEL, but selects the pixel data of two pixels and adjusts the selected pixel data to produce the pixel data of the two pixels, which includes the setting value of one pixel of the non-partial window (indicated by the hatched grid in front of the pixel 4 of 553) and the pixel data of the row of beginning 1 pixel (i.e., the pixel data of the pixel 4). In the condition shown by 553, the pixel data of the pixel 3 is modified into the setting value of the pixel of the non-partial window. For example, a constant, such as 0, is modified using a data mask. Thus, the operations of 552 and 553 are similar to the operations of changing the position where the data mask functions. The outputs of the data of 554 and 555 and the pixel data of other portions of the partial window may be performed in a similar manner, so detailed descriptions thereof will not be detailed for the sake of brevity.

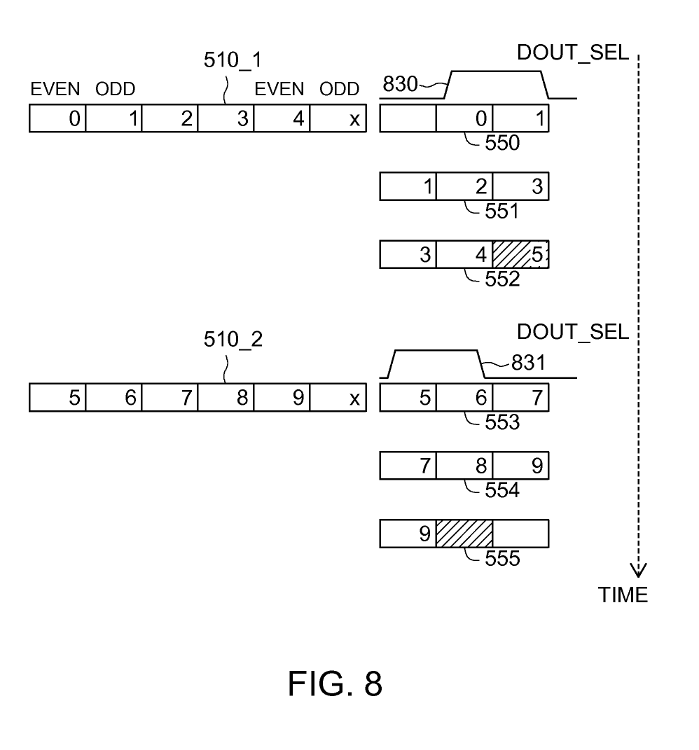

In the fourth condition, P is equal to 2, and the values M and N of the first and second vertical boundaries are even numbers. FIG. 8 is a schematic illustration showing an embodiment of the operation of the data output selection unit 415 of the data collection circuit of FIG. 4 when the vertical boundaries of the partial window are even numbers.

In FIG. 8, the symbol 550 represents that the memory of the data output selection unit 415 receives the pixel data of the first row of beginning P (P=2) pixels of the partial window. The condition of FIG. 8 is the same as that represented by 550 of FIG. 5, and the condition shown by 550 is also like this. Next, the symbol 552 represents that the memory receives the pixel data of the successive P (P=2) pixels of the partial window (i.e., the pixel data of the pixels 4 and 5). What is different from FIGS. 5 and 6 will be described in the following. Because the pixel data of the pixel 4 is the ending portion of the first row of the partial window, the data output selection unit 415 selects the pixel data of P (P=2) pixels and adjusts the selected pixel data to produce the pixel data of the P pixels for output. The pixel data of the two pixels produced after adjustment includes the pixel data of one pixel (i.e., the pixel data of the pixel 4) and the setting value of one pixel of the non-partial window (indicated by the hatched grid in back of the pixel 4 of 552). This processing method is similar to that shown by 552 of FIG. 7.

Similarly, the symbols 553 to 555 of FIG. 8 represent the outputs of the pixel data of the successive second row of the partial window, and the final order is shown by the second row portion 510_2. In the condition indicated by 552, the pixel data of the pixel 5 is the pixel data of one beginning pixel of the successive second row of the partial window. So, as shown by 553 of FIG. 8, the control unit 419 needs to output the data request signal DATA_REQ and change the selection position of the data output selection signal DOUT_SEL. In addition, the memory of the data output selection unit 415 receives the pixel data of the successive P (P=2) pixels of the second row of the partial window, and makes the pixel data of the previous pixel move forwards. The data output selection unit 415 selects the pixel data of two pixels (i.e., the pixel data of the pixels 5 and 6) according to the data output selection signal DOUT_SEL shown by 831, and the selected pixel data serves as its output. The outputs of the data of 554 and 555 and the pixel data of other portions of the partial window may be analogized, so detailed descriptions thereof will be omitted.

In addition, the method according to the embodiment of the invention sequentially processes the pixel data of the partial window in the partial mode so that the processed pixel data may be provided to the data driving circuit of the flat display panel having the partial mode and the partial window may be displayed. This method includes the following steps. In step (a), when the data driving circuit is in the partial mode, it is determined whether to sequentially read the pixel data of the plurality of pixels of the pixel data of the partial window from the data area to temporarily store the read pixel data into the memory according to the boundary of the partial window and the scan count. In step (b), when the scan count indicates that the partial window is to be displayed, the pixel data of P pixels is selected from the temporarily stored pixel data of the pixels, and thus produces the pixel data of the P pixels to the data driving circuit every time so as to sequentially output the pixel data of the partial window to drive the flat display panel to display the partial window. This data area stores the pixel data of each row of the partial window, wherein P is a positive integer greater than 1.

In the step (b), when P is an even number and the value M of the first vertical boundary is an odd number, with regard to each row of beginning pixel data of the partial window, the pixel data of the P pixels produced according to the boundary of the partial window and the scan count includes setting values of an odd number of pixels of the non-partial window and the pixel data of the row of beginning odd number of pixels, as shown by the data processing indicated by 550 or 553 in FIGS. 6 and 7, for example.

In the step (b), when P is an even number and the value N of the second vertical boundary is an even number, with regard to each row of ending pixel data of the partial window, the pixel data of P pixels produced according to the boundary of the partial window and the scan count includes the pixel data of the row of ending odd number of pixels and the setting values of the odd number of pixels of the non-partial window, as shown by the data processing indicated by 552 or 555 in FIGS. 6 and 7, for example.

In addition, in the step (b), when the pixel data of the adjacent two row of pixels of the partial window is being processed, it is judged whether to perform at least one of operations or not according to different conditions and according to the boundary of the partial window, the scan count and the value of P, or according to whether the pixel data of the partial window has been completely read. The operations include: reading the successive pixel data; changing the position of the pixel data of the P pixels selected from the temporarily stored pixel data of the pixels, which may be implemented by, for example the data output selection signal; and changing the setting of the position of the pixel value of the non-partial window (e.g., setting or changing the position where the data mask functions) to obtain the produced pixel data of the P pixels, as shown by the data processing indicated by 550 or 555 in FIGS. 5 to 8, for example.

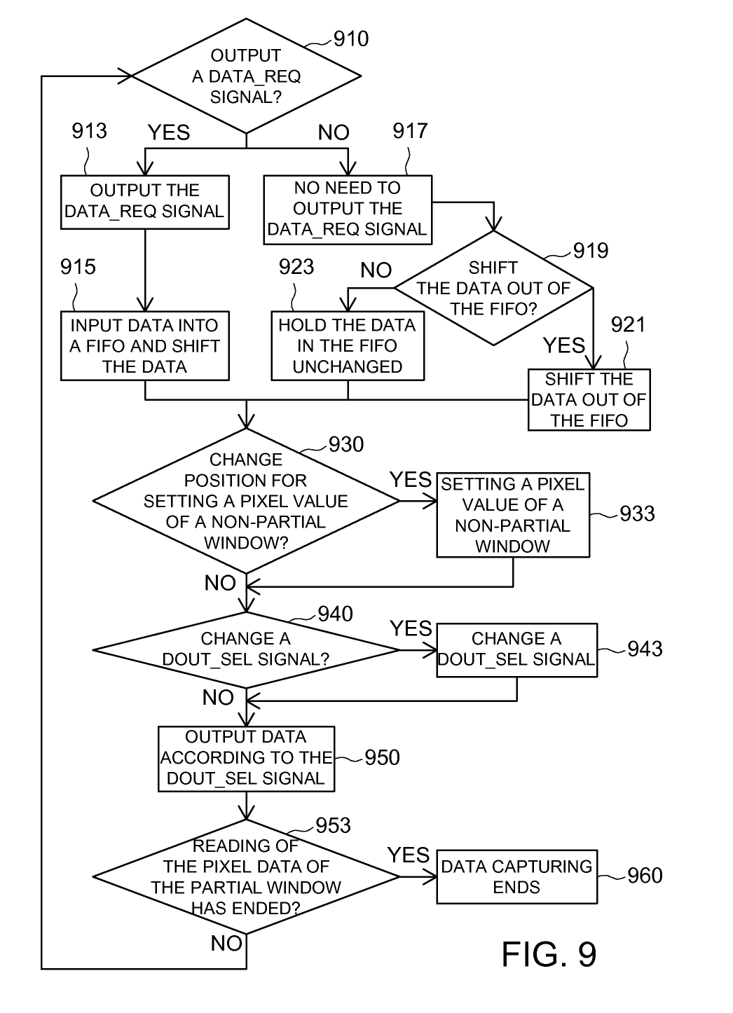

FIG. 9 shows a method of the data collection circuit of FIG. 4 for processing the pixel data of the partial window according to an embodiment of the invention. The embodiment of FIG. 9 is made based on the pixel data processing method mentioned hereinabove. The data collection circuit processes the pixel data of the partial window based on the preconditions of the boundary of the partial window and the scan count with respect to the odd-even problem of the boundary and the pixel data of P pixels outputted from the data collection circuit every time. In FIG. 9, as shown in step 910, it is judged whether to output the data request signal DATA_REQ or not. If so, as shown in step 913, the data request signal DATA_REQ is outputted so that a portion of the pixel data of the partial window is sequentially obtained from the data source. In step 915, the pixel data obtained in the step 913 is inputted to the FIFO, and the old data in the FIFO is shifted. If the step 910 determines that the data request signal DATA_REQ needs not to be outputted, as shown in the block 917, it is judged whether the data (e.g., the pixel data of P pixels, wherein the same condition is applied to the following examples) has to be shifted out of the FIFO, as shown in step 919. If so, as shown in step 921, the data is shifted out of the FIFO. If not, the data in the FIFO is held unchanged, as shown by block 923. Next, step 930 determines whether to change the setting of the position of the pixel value of the non-partial window. If so, the pixel value of the non-partial window is set, as shown in step 933. In FIGS. 6 to 8, for example, the condition of the pixel value of the non-partial window is involved. Next, step 940 determines whether to change the data output selection signal DOUT_SEL or not. If so, as shown in step 943, the data output selection signal DOUT_SEL is set, as shown in the condition of changing the data output selection signal DOUT_SEL in FIGS. 6 and 8. Next, as shown in step 950, the data (e.g., the pixel data of P pixels) is outputted according to the data output selection signal DOUT_SEL. Step 953 determines whether the reading of the pixel data of the partial window has ended or not. If so, as shown in step 960, the data capturing ends. If not, the above-mentioned steps are repeated until the pixel data of the partial window has been completely read.

In other embodiments, those skilled in the art may analogize various conditions with P is the odd number according to the above-mentioned embodiments.

The invention has disclosed the data driving circuit of the flat display panel with the partial mode and the method for processing the pixel data of the partial window in the above-mentioned embodiments. According to the embodiments of the invention, the driving circuit can capture the pixel data at the lower frequency. Taking the liquid crystal display panel with the resolution of 480×864 as an example, when the scan frequency is 60 Hz, a half clock of about 25 MHz may be adopted to control the reading of the pixel data of two pixels (i.e., the condition where P is 2) every time. In addition, the left and right boundaries of the partial window may be set more flexibly in the partial mode, the pixel data of the partial window can be smoothly and correctly displayed, and the power consumption in the partial mode may be further reduced.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data driving circuit for driving a flat display panel, the data driving circuit comprising:
an input register for storing pixel data of one row of pixels of the display panel and outputting the pixel data of the one row of pixels, wherein the input register receives pixel data of a plurality of pixels each time to provide pixel data of the row of pixels; and
a data collection circuit, wherein when the data driving circuit is in a partial mode, the data collection circuit determines whether to sequentially read pixel data of a plurality of pixels of the pixel data of a partial window from a data area according to a boundary of the partial window and a scan count and temporarily stores the read pixel data into the data collection circuit;
when the scan count indicates that the partial window is to be displayed, the data collection circuit selects pixel data of a plurality of pixels from the temporarily stored pixel data of the pixels and accordingly produces the pixel data to the input register every time so as to sequentially output the pixel data of the partial window to drive the flat display panel to display the partial window; and
the data area stores the pixel data of the partial window.

2. The circuit according to claim 1, wherein the input register receives the pixel data of P pixels every time, and the data collection circuit comprises:
a first-in-first-out (FIFO) memory cell;
a data output selection unit for storing pixel data, outputted from the FIFO memory cell, in a FIFO manner, and producing processed pixel data of P pixels every time according to a data output selection signal;
a control unit for determining whether to output a data request signal according to the boundary of the partial window and the scan count, and thus sequentially reading the pixel data of the P pixels of the pixel data of the partial window from the data area, and temporarily storing the read pixel data into the FIFO memory cell;
wherein when the control unit determines that the scan count as indicating that the partial window is to be displayed, the control unit controls the FIFO memory cell to output the pixel data to the data output selection unit, and the control unit outputs the data output selection signal to make the data output selection unit select the pixel data of the P pixels from the stored pixel data outputted from the FIFO memory cell, and thus produce the pixel data of the P pixels, wherein P is a positive integer greater than 1.

3. The circuit according to claim 2, wherein the boundary of the partial window comprises a first vertical boundary, a second vertical boundary, a first horizontal boundary and a second horizontal boundary, when the control unit determines the scan count as indicating that the partial window is to be displayed according to the boundary of the partial window and the scan count, the control unit sequentially outputs the data request signal to sequentially read pixel data of a plurality of pixels of the pixel data of the partial window from the data area and temporarily stores the read pixel data into the FIFO memory cell, wherein a value of the first vertical boundary is smaller than a value of the second vertical boundary.

4. The circuit according to claim 3, wherein P is an even number, and the values of the first and second vertical boundaries are respectively an even number and an odd number.

5. The circuit according to claim 3, wherein when P is an even number and the value of the first vertical boundary is an odd number, the control unit outputs the data output selection signal to make the pixel data of the produced P pixels include setting values of an odd number of pixels of a non-partial window and the pixel data of the row of beginning odd number of pixels according to the boundary of the partial window and the scan count, with respect to each row of beginning pixel data of the partial window.

6. The circuit according to claim 3, wherein when P is an even number and the value of the second vertical boundary is an even number, the control unit outputs the data output selection signal to make the pixel data of the produced P pixels include the pixel data of the row of ending odd number of pixels and setting values of an odd number of pixels of a non-partial window according to the boundary of the partial window and the scan count, with respect to each row of ending pixel data of the partial window.

7. The circuit according to claim 3, further comprising a shift register for controlling the input register according to a clock signal, wherein the input register receives pixel data of a plurality of pixels according to each clock of the clock signal to provide the pixel data of the row of pixels.

8. A data collection circuit for sequentially processing pixel data of a partial window and thus providing the processed data to a data driving circuit of a flat display panel to display the partial window, the data collection circuit comprising:
a first-in-first-out (FIFO) memory cell;
a data output selection unit for storing pixel data outputted from the FIFO memory cell, and producing processed pixel data of P pixels according to a data output selection signal every time; and
a control unit for determining whether to output a data request signal according to a boundary of the partial window and a scan count so as to sequentially read pixel data of P pixels of the pixel data of the partial window from a data area and temporarily store the read pixel data into the FIFO memory cell;
wherein when the control unit determines that the scan count as indicating that the partial window is to be displayed, the control unit controls the FIFO memory cell to output the pixel data to the data output selection unit for storage, and the control unit outputs the data output selection signal to make the data output selection unit select the pixel data of the P pixels from the stored pixel data outputted from the FIFO memory cell, and thus produce the pixel data of the P pixels, wherein P is a positive integer greater than 1.

9. The circuit according to claim 8, wherein the boundary of the partial window comprises a first vertical boundary, a second vertical boundary, a first horizontal boundary and a second horizontal boundary, when the control unit determines the scan count as indicating that the partial window is to be displayed according to the boundary of the partial window and the scan count, the control unit sequentially outputs the data request signal to sequentially read pixel data of a plurality of pixels of the pixel data of the partial window from the data area and temporarily stores the read pixel data into the FIFO memory cell, wherein a value of the first vertical boundary is smaller than a value of the second vertical boundary.

10. The circuit according to claim 9, wherein P is an even number, and the values of the first and second vertical boundaries are respectively an even number and an odd number.

11. The circuit according to claim 9, wherein when P is an even number and the value of the first vertical boundary is an odd number, the control unit outputs the data output selection signal to make the pixel data of the produced P pixels include setting values of an odd number of pixels of a non-partial window and the pixel data of the row of beginning odd number of pixels according to the boundary of the partial window and the scan count, with respect to each row of beginning pixel data of the partial window.

12. The circuit according to claim 9, wherein when P is an even number and the value of the second vertical boundary is an even number, the control unit outputs the data output selection signal to make the pixel data of the produced P pixels include the pixel data of the row of ending odd number of pixels and setting values of an odd number of pixels of a non-partial window according to the boundary of the partial window and the scan count, with respect to each row of ending pixel data of the partial window.

13. The circuit according to claim 9, wherein when pixel data of two adjacent rows of pixels of the partial window is being processed, the control unit determines whether to perform at least one of operations according to the boundary of the partial window, the scan count and a value of P, wherein the operations comprise: reading successive pixel data, changing positions of the pixel data of the P pixels selected from the temporarily stored pixel data of the pixels, and changing positions of pixel values of setting a non-partial window to obtain the produced pixel data of the P pixels.

14. A method for sequentially processing pixel data of a partial window in a partial mode to provide a data driving circuit of a flat display panel to display the partial window, the method comprising the steps of:
(a) determining whether to sequentially read pixel data of a plurality of pixels of the pixel data of the partial window from a data area to temporarily store the read pixel data into the memory cell according to a boundary of the partial window and a scan count when the data driving circuit is in the partial mode;
(b) selecting pixel data of P pixels from the temporarily stored pixel data of the pixels when the scan count indicates that the partial window is to be displayed, and thus producing pixel data of P pixels to the data driving circuit every time so as to sequentially output the pixel data of the partial window to drive the flat display panel to display the partial window, wherein the data area stores the pixel data of the partial window, and P is a positive integer greater than 1.

15. The method according to claim 14, wherein the boundary of the partial window comprises a first vertical boundary, a second vertical boundary, a first horizontal boundary and a second horizontal boundary, when the scan count is judged as indicating that the partial window is to be displayed according to the boundary of the partial window and the scan count, pixel data of a plurality of pixels of the pixel data of the partial window is sequentially read from the data area to temporarily store the read pixel data into the memory cell, wherein a value of the first vertical boundary is smaller than a value of the second vertical boundary.

16. The method according to claim 15, wherein P is an even number, and the values of the first and second vertical boundaries are respectively an even number and an odd number.

17. The method according to claim 15, wherein the step (b) comprises:
making the pixel data of the produced P pixels include setting values of an odd number of pixels of a non-partial window and the pixel data of the row of beginning odd number of pixels according to the boundary of the partial window and the scan count with respect to each row of beginning pixel data of the partial window, when P is an even number and the value of the first vertical boundary is an odd number.

18. The method according to claim 15, wherein the step (b) comprises:
making the pixel data of the produced P pixels include the pixel data of the row of ending odd number of pixels and setting values of an odd number of pixels of a non-partial window according to the boundary of the partial window and the scan count with respect to each row of ending pixel data of the partial window, when P is an even number and the value of the second vertical boundary is an even number.

19. The method according to claim 15, wherein the step (b) comprises:
it is judged whether to perform at least one of operations according to the boundary of the partial window, the scan count and a value of P such that the pixel data of the partial window is sequentially outputted to drive the flat display panel to display the partial window when pixel data of two adjacent rows of pixels of the partial window is being processed, wherein the operations comprise: reading successive pixel data, changing positions of the pixel data of the P pixels selected from the temporarily stored pixel data of the pixels, and changing positions of pixel values of setting a non-partial window to obtain the produced pixel data of the P pixels.

20. The method according to claim 15, wherein changing the setting of the position of the pixel value of the non-partial window comprises:
setting the pixel data of a portion of the pixels as a setting value from the pixel data of the P pixels, selected from the temporarily stored pixel data of the pixels, according to the boundary of the partial window, the scan count and the value of P.
